(19) United States
(12) Patent Application Publication
(10) Pub. No.: US 2025/0167373 A1
(43) Pub. Date: May 22, 2025

(54) Battery for Electric Tool, and Electric Tool

(71) Applicant: Robert Bosch GmbH, Stuttgart (DE)

(72) Inventors: Lijuan Xia, Shanghai (CN); Lei Bao, Shanghai (CN); Chee Khiang Tan, Shanghai (CN); Yun Jiang, Shanghai (CN); Chichen Bao, Shanghai (CN)

(21) Appl. No.: 18/840,564

(22) PCT Filed: Feb. 14, 2023
(86) PCT No.: PCT/CN2023/075882

§ 371 Date: Aug. 22, 2024

(30) Foreign Application Priority Data
Feb. 25, 2022 (CN) 2022 2039 1878.2

(51) Int. Cl. H01M 50/247; H01M 10/42; H01M 10/48; H02K 11/00; H02K 11/20

(52) U.S. Cl. CPC H01M 50/247; H01M 10/425; H01M 10/486; H02K 11/20; H01M 2220/30; H02K 11/0094

(57) ABSTRACT

An electric tool includes an electric motor and a battery for supplying electric power to the motor. The battery includes: a battery cell; a control device integrated into the battery cell, the control device comprising an inertial measurement unit and a communication and control module, wherein the inertial measurement unit includes: at least one sensor configured to measure at least one motion parameter of the electric tool, and a controller configured to receive the motion parameter output by the at least one sensor and generate a state indication signal indicating the motion state of the electric tool; the communication and control module comprising: a communication unit configured to communicate with external devices, and a processor configured to receive the state indication signal and generate a switch control signal; a switch network configured to receive the switch control signal generated by the control device and control the power output of the battery based on the switch control signal.

### TECHNICAL FIELD

The present application relates to a battery for use in an electric tool, and also relates to an electric tool comprising such a battery.

### PRIOR ART

Electric tools are commonly used to perform tasks such as drilling holes in walls, cutting, fastening, and impacting. However, during actual use, due to the specificity of tasks and operational errors or inability to hold the tool properly, there can occasionally be safety issues, such as recoil or dropping of the electric tool during operation. If the motor is still in a rotating state at this time, the recoil or dropping of the electric tool may cause damage to the tool or injury to other objects (e.g., people or property). Therefore, it is necessary to implement safety measures to mitigate potential risks associated with electric tools. Additionally, due to the nature of the tasks, electric tools may also face issues such as lifespan or malfunctions. It is also very useful to conveniently collect information about the electric tool.

### SUMMARY OF THE INVENTION

The present application aims to provide a protection mechanism for electric tools implemented through an intelligent battery.

According to one aspect of the present application, a battery for an electric tool is provided, comprising: a battery cell; a control device integrated into the battery cell, the control device comprising an inertial measurement unit and a communication and control module, wherein the inertial measurement unit includes: at least one sensor configured to measure at least one motion parameter of the electric tool, and a controller configured to receive the motion parameter output by the at least one sensor and generate a state indication signal indicating the motion state of the electric tool; the communication and control module comprising: a communication unit configured to communicate with external devices, and a processor configured to receive the state indication signal and generate a switch control signal; a switch network configured to receive the switch control signal generated by the control device and control the power output of the battery based on the switch control signal.

In one embodiment, the inertial measurement unit further includes a timer configured to measure the duration of the motion state; wherein the controller is configured to generate different state indication signals based on the motion parameter and the duration; wherein the processor is configured to generate different switch control signals based on the different state indication signals.

In one embodiment, the controller is configured to output a state indication signal when the duration exceeds a preset time threshold, such that the processor generates a switch control signal based on the state indication signal to control the switch network to cut off the power output of the battery.

In one embodiment, the controller is configured to output a first state indication signal when the duration exceeds a first time threshold, such that the processor generates a first switch control signal based on the first state indication signal to control the switch network to reduce the power output of the battery; and the controller is further configured to output a second state indication signal when the duration exceeds a second time threshold greater than the first time threshold, such that the processor generates a second switch control signal based on the second state indication signal to control the switch network to cut off the power output of the battery.

In one embodiment, the processor is configured to generate a switch control signal to restore the power output of the battery to control the switch network to restore the power output of the battery after reducing or cutting off the power output of the battery, based on the motion parameter indicating a normal motion state.

In one embodiment, the motion parameter comprises 3-axis acceleration (αₓ, α_{y}, α_{z}) from the sensor, and the controller is configured to generate and output the state indication signal when (αₓ²+α_{y}²+α_{z}²)^{1/2} is less than a preset acceleration threshold, the state indication signal representing a fall of the electric tool.

In one embodiment, the controller is further configured to confirm the state indication signal as valid when the integral of (1−(αₓ²+α_{y}²+α_{z}²)^{1/2}) over time reaches a preset speed threshold, and generate and output the state indication signal representing a fall of the electric tool only when the state indication signal is confirmed as valid.

In one embodiment, the motion parameter further comprises 3-axis angular velocity (ωₓ, ω_{y}, ω_{z}) from the sensor, the controller being configured to generate and output the state indication signal when the value or sudden change of one of the 3-axis angular velocities or (ωₓ²+ω_{y}²+ω_{z}²)^{1/2} reaches a preset angular velocity threshold, the state indication signal representing a recoil of the electric tool.

In one embodiment, the controller is further configured to confirm the state indication signal as valid when the integral of one of the 3-axis angular velocities or (ωₓ²+ω_{y}²+ω_{z}²)^{1/2} over time reaches a preset angular threshold, and generate and output the state indication signal representing a recoil of the electric tool only when the state indication signal is confirmed as valid.

In one embodiment, the controller is configured to generate different state indication signals with a unified parameter format but different signal parameter values to respectively indicate different motion states.

In one embodiment, the controller is a programmable microcontroller specifically optimised for sensor fusion and motion recognition algorithms.

In one embodiment, the control device also includes: an update unit configured to receive control commands for updating or extending the functions of the electric tool from the external device through the communication unit.

In one embodiment, the update unit is disposed within the communication and control module or within the inertial measurement unit.

In one embodiment, the update unit is implemented by the processor or the controller.

In one embodiment, the processor is configured to send data related to the electric tool or the battery to the external device and receive instructions related to the electric tool or the battery from the external device, or modify the operating parameters related to the electric tool or the battery through the communication unit.

In one embodiment, the communication unit includes at least one of the following:
a Bluetooth module;
an NB-IoT module;
a wireless cellular module;
a positioning module.

In an embodiment, the sensor and the controller are integrated within a single chip package.

In an embodiment, the processor is configured to monitor the temperature of the battery cell and reduce or cut off the power output of the battery cell when the monitored temperature of the battery cell exceeds a preset temperature threshold.

In an embodiment, the processor is configured to monitor the temperature of the battery cell through the resistance value of an Negative Temperature Coefficient (NTC) resistor in the temperature monitoring circuit of the battery cell.

The present application, in another aspect, provides an electric tool comprising: an electric motor; the battery of the present application, configured to output power to the electric motor; wherein the switch network in the battery controls the power output of the battery to the electric motor based on the switch control signal.

According to the present application, the battery for an electric tool is integrated with communication and control functions, providing a protection mechanism for the electric tool, which can control the battery power supply to prevent damage to the electric tool or other objects in the event of an accident. Additionally, the battery of the present application is suitable for different electric tools and is easy to maintain and manage.

### DESCRIPTION OF ACCOMPANYING DRAWINGS

By considering the detailed description and the accompanying drawings, other features, embodiments, and aspects of the present application will be readily understood. In the accompanying drawings,

FIG. 1 illustrates a block diagram of an IMU configuration according to an example of the present application;

FIG. 2 illustrates a block diagram of a battery configuration according to an example;

FIG. 3 illustrates a drop monitoring procedure according to an example;

FIG. 4 illustrates a kickback monitoring procedure according to an example;

FIG. 5 illustrates a communication schematic of an electric tool according to an example.

### SPECIFIC EMBODIMENTS

Before explaining any embodiment of the present application in detail, it should be understood that the application is not limited to the construction details and component arrangements set forth in the following description or illustrated in the accompanying drawings. The present application can have other embodiments and can be practiced or implemented in various ways. Where appropriate and applicable, any feature described in connection with one aspect or embodiment of the present application can be combined with any other feature described in connection with any other aspect or embodiment of the present application. Additionally, it should be understood that the wording and terminology used in the present application are for the purpose of description and should not be considered as limiting.

In conventional electric tools, an inertial measurement unit (IMU) integrated into the electric tool is typically used to measure the motion parameters of the electric tool. For example, an accelerometer or gyroscope in the IMU can be used to measure acceleration or angular velocity, and the measured motion parameters are provided to the central processing unit (CPU) of the electric tool. The IMU is electrically coupled to the CPU and located on the body of the electric tool, whereby the CPU can, based on pre-programmed and installed motion detection programs, detect abnormal states of the electric tool, such as kickback or drop, by processing the measurement parameters received from the sensors, and perform corresponding control actions, such as cutting off or reducing the power supply from the battery to the motor. However, since the IMU is integrated into the electric tool and the motion detection program is implemented by the CPU on the body of the electric tool, this motion detection mechanism can only be applied to the current electric tool and cannot be adapted to other electric tools that do not have the motion detection program installed. Specifically, since the CPU, as a general-purpose processor, also needs to perform other preset functions, such as control or networking according to a certain communication protocol, having the CPU on the body of the electric tool execute the motion detection program not only increases the burden on the CPU but also brings unnecessary burdens for software updates to the CPU. For example, when updating or adding new motion detection programs, considerations such as the CPU's communication protocol may need to be taken into account. The present application provides a motion detection scheme that can be flexibly adapted to different electric tools.

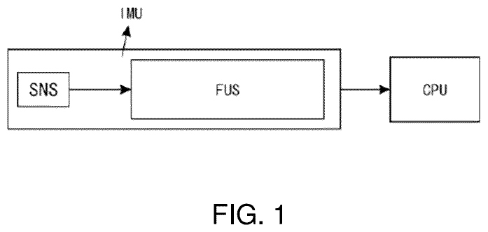

FIG. 1 illustrates an improved Inertial Measurement Unit (IMU) that can be employed in the electric tool of this application. In addition to containing one or more traditional motion sensors (SNS), the IMU also includes a programmable embedded controller, such as a data signal processing module (Fuser Core) or other types of microcontrollers, hereinafter collectively referred to as FUS. According to an example of this application, motion detection programs based on multiple sensors (SNS), such as a drop detection program (DropProgram) and a kick-back detection program (Kick-BackProgram), are programmed onto the FUS. In this example, the FUS is integrated with the sensors (SNS), for instance, forming a single-chip package. Multiple sensors (SNS) in the IMU are used to detect the current state of the electric tool and output motion parameters (MotionVar). In one example, the sensors integrated into the IMU include, but are not limited to, a 3-axis gyroscope, a 3-axis accelerometer, etc., and the FUS employs a programmable microcontroller, such as an ultra-low-power 32-bit microcontroller. Here, the microcontroller can be optimised and customised specifically for sensor fusion and motion recognition algorithms, significantly reducing power consumption compared to standard microcontrollers. In this example, a 3-axis accelerometer can be used to obtain acceleration α in the 3-axis, and a 3-axis gyroscope can be used to obtain the angular velocity ω around the 3-axis. The FUS performs motion detection operations, such as executing the drop detection program and the kick-back detection program, by processing motion parameters output from multiple sensors in the IMU, such as acceleration or angular velocity, to generate an indication signal regarding the current motion state of the electric tool.

In one example, the IMU containing the programmable embedded controller (FUS) can be installed as a separate component in the electric tool or its battery and powered by the battery. Thus, when the controller (FUS) in the IMU detects an abnormal state, such as a drop or kick-back, the generated state indication signal is provided as an interrupt to the CPU located inside the electric tool or battery, allowing the CPU to respond directly based on the signal. This relieves the CPU from the burden of directly executing drop or kick-back detection.

In the actual use of electric tools, users typically need to collect information about their electric tool equipment, such as tool usage efficiency, fault statistics, power monitoring, and positioning. This information is usually collected or control commands are sent through a wireless interface (e.g., a wireless transceiver, including Bluetooth, etc.) located on the electric tool. However, these communication modules located on the electric tool body bring inconvenience for communication expansion, and for electric tools without a wireless interface, information collection is not possible.

Therefore, in a preferred embodiment of this application, to achieve secure control and communication on different electric tools, this example fully utilises the convenience of the electric tool's battery and its adaptability to different standard tools, providing a battery with secure control and communication functions. In this example, the IMU is integrated with the communication module and the general-purpose processor (CPU), allowing the integrated CPU to complete the preset functions for controlling the electric tool.

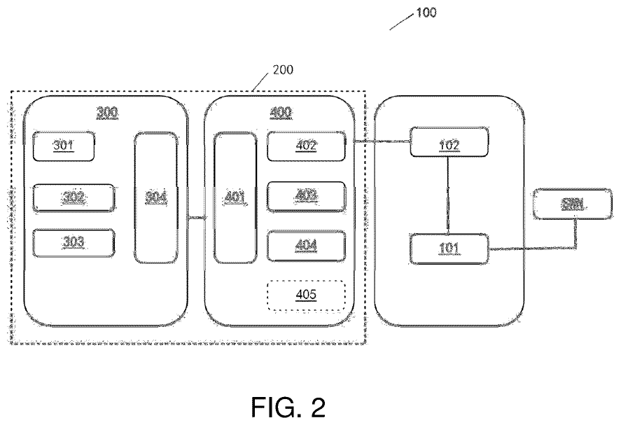

FIG. 2 illustrates a battery 100 suitable for an electric tool according to an embodiment of the present application. The battery 100 is configured to be detachably attached to the electric tool body As shown in FIG. 2, the battery 100 includes one or more sets of battery cells 101, a switch network 102 for controlling the output power or current of the battery cells 101, where the switch network 102 is configured to be electrically coupled to the motor SWN of the electric tool to provide the output power of the battery cells 101 to the motor SWN. Thus, when the user triggers the switch of the electric tool, the battery cells 101 can power the motor SWN, causing the motor SWN to drive the tool head of the electric tool to perform the corresponding operation. Additionally, the battery 100 includes a control device 200, which is integrated into the battery cells 101, either permanently or detachably mounted on the battery cells 101. As shown in FIG. 2, the control device 200 comprises two parts, namely an Inertial Measurement Unit (IMU) 300 and a communication/control module 400.

As shown in FIG. 2, the IMU 300 includes multiple sensors SNS, such as a 3-axis accelerometer 301, a 3-axis gyroscope 302, and a timer 303 for timing the motion state. Furthermore, the IMU 300 also integrates a microcontroller (FUS) 304. In this example, the FUS 304 is implemented using a programmable microcontroller, such as a 32-bit microcontroller, where the 3-axis accelerometer 302 obtains an acceleration a in 3-axis direction, and the 3-axis gyroscope obtains an angular velocity ω around the 3-axis. The FUS 304 performs motion detection operations, such as a fall detection program or a recoil detection program, by diagnosing the motion state of the device based on motion parameters, such as acceleration, output by at least part of the multiple sensors in the IMU 300, thereby generating an indication signal regarding the current motion state. The communication/control module 400 includes a central processing unit or processor 401 for general control and a general communication module or communication unit, such as a WiFi module 402, a Narrowband Internet of Things (NB-IoT) module 403, and a positioning module 404, among others. The processor 401 is configured to send data related to the electric tool or battery to the external device and receive instructions related to the electric tool or battery from the external device via the communication unit, or to modify the operating parameters related to the electric tool or battery. Of course, the communication module integrated into the control device 200 is not limited to the aforementioned examples and may also include a Bluetooth module or a wireless cellular module, etc. Thus, when the battery 100 is attached to the electric tool body, all control and communication functions of the electric tool can be implemented on the battery 100 to form a smart battery. When the battery 100 is combined with the electric tool, during the operation of the electric tool, the battery 100 can execute safety functions such as a fall monitoring program and a recoil monitoring program.

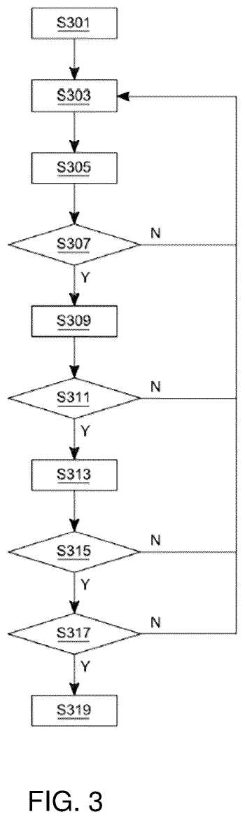

The following describes a fall monitoring program executable by the battery 100 according to an example of the present application in conjunction with FIG. 3. As shown in FIG. 3, the fall monitoring program starts at step S301.

In step S303, FUS 304 receives acceleration information α in three axial directions at the current moment from the 3-axis accelerometer 301.

In step S305, the acceleration information α undergoes necessary filtering and normalization processing to obtain the processed acceleration information α corresponding to the current moment.

In step S307, FUS 304 determines whether the electric tool is in a falling state based on the processed acceleration information α.

It should be noted here that the three axes of the 3-axis accelerometer 301 are assumed to be the X (lateral) axis, Y (longitudinal) axis, and Z (vertical) axis. The acceleration information α output by the 3-axis accelerometer 301 includes acceleration information in these three axial directions, i.e., acceleration components (αₓ, α_{y}, α_{z}). When the 3-axis accelerometer 301 is in a stationary state in a horizontal posture, the three acceleration components are (0, 0, 1), with the unit being gravitational acceleration. When the 3-axis accelerometer 301 is in a stationary state in other postures, it satisfies (αₓ²+α_{y}²+α_{z}²)^{1/2}=1. When the 3-axis accelerometer 301 falls from a stationary state, considering air resistance or other resistances, the output three acceleration components satisfy (αₓ²+α_{y}²+α_{z}²)^{1/2} approaching 0. Therefore, the falling state of the electric tool can be determined based on the value of (αₓ²+α_{y}²+α_{z}²)^{1/2} representing the acceleration. For example, an acceleration threshold α_{TH} less than 1 can be set, such as 0.5, 0.3, 0.2, 0.1, or similar values. When (αₓ²+α_{y}²+α_{z}²)/2<α_{TH}, it can be determined that the electric tool is in a falling state. The acceleration threshold α_{TH} can be set based on experimental tests.

If the determination result in step S307 is “yes,” i.e., the electric tool is determined to be in a falling state, the program proceeds to step S309. If the determination result in step S307 is “no,” i.e., the electric tool is not in a falling state, the program returns to step S303.

In step S309, the timer 303 starts timing.

In step S311, it is determined whether the timing of the timer 303 reaches a preset time threshold T_{TH1} and whether (αₓ²+α_{y}²+α_{z}²)^{1/2}<α_{TH} is continuously satisfied during the period from the start of timing to reaching the time threshold T_{TH1}.

If the determination result in step S311 is “yes,” the program proceeds to step S313.

If the determination result in step S311 is that the timing of the timer 303 has not reached the preset time threshold T_{TH1}, the program returns to step S303. Thus, continuous monitoring of the acceleration information α is achieved through steps S303 to S307, and if the determination result in step S307 is “yes,” continuous timing of the timer 303 is achieved through step S309. If (αₓ²+α_{y}²+α_{z}²)^{1/2} is no longer <α_{TH} but approaches or equals 1 when the timing reaches the time threshold T_{TH1}, it indicates that the electric tool may have returned to a normal state or the risk has been reduced. The timer 303 is reset, and the program returns to step S303 to continue monitoring the output of the 3-axis accelerometer 301.

In step S313, FUS 304 outputs a status indication signal Stat_SIG₁ representing the occurrence of a fall and continues to monitor the timing and acceleration information. The status indication signal Stat_SIG₁ is provided as an interrupt to CPU 401. After receiving the status indication signal Stat_SIG₁, CPU 401 generates a switch control signal SIG_{CTR1} to control the switch network 102 to reduce the supply current from the battery unit 101 to the electric motor SWN, thereby reducing the speed and torque output of the electric motor SWN. The purpose of reducing the speed of the electric motor SWN here is to take preventive steps to reduce potential risks.

In step S315, it is determined whether the timing has reached another preset time threshold T_{TH2} (T_{TH2} is greater than T_{TH1}). If the determination result is “yes,” the program proceeds to step S317; if the determination result is “no,” the program returns to step S303.

In step S317, it is determined whether (αₓ²+α_{y}²+α_{z}²)¹2<α_{TH} is still satisfied; if the determination result is “yes,” the program proceeds to step S319.

In step S319, FUS 304 outputs a status indication signal Stat_SIG₂ representing the continuation of the fall. After receiving the status indication signal Stat_SIG₂, CPU 401 generates a switch control signal SIG_{CTR2} to control the switch network 102 to cut off the power supply from the battery unit 101 to the electric motor SWN, thereby stopping the operation of the electric motor SWN to avoid damage to the electric tool or other objects.

If the determination result in step S317 is “no,” FUS 304 outputs a status indication signal Stat_SIG₃ representing the end of the fall. This signal Stat_SIG₃ can be, for example, a reset signal. After receiving Stat_SIG₃, CPU 401 generates a control signal SIG_{CTR3} to control the switch network 102 to restore the normal power supply from the battery unit 101 to the electric motor SWN, thereby restoring the normal speed of the electric motor SWN. The timer 303 is reset, and the program returns to step S303.

In this example, the time thresholds T_{TH1} and T_{TH2} represent the fall time of the electric tool. Obviously, the longer the time, the greater the fall height, and thus the greater the potential damage to the electric motor SWN. For example, this situation may occur when the electric tool falls from a high place (such as from a worker's hand on a ladder). Typically, T_{TH1} can be set to a fall time exceeding 0.5 seconds, and T_{TH2} to a fall time exceeding 2 seconds.

Those skilled in the art can make various adaptive modifications to the fall monitoring program described above based on specific applications. For example, in the scheme where the fall state of the electric tool is determined using acceleration information α output by the 3-axis accelerometer 301, speed information derived from the acceleration information α can also be combined as an auxiliary validity judgment basis to improve the accuracy and reliability of the fall determination. For instance, the speed can be represented by integrating V=(1−(αₓ²+α_{y}²+α_{z}²)^{1/2}) over time. At a certain time threshold (e.g., T_{TH1} and/or T_{TH2}), if (αₓ²+α_{y}²+α_{z}²)^{1/2}<α_{TH} and V is greater than a preset speed threshold V_{TH}, it can be determined that the electric tool is in a falling state. If at this time threshold, although (αₓ²+α_{y}²+α_{z}²)^{1/2}<α_{TH}, V does not reach the speed threshold V_{TH}, the above judgment can be repeated at a time point after this time threshold.

Furthermore, in the examples described earlier, the power supply from the battery unit 101 to the motor SWN is reduced and cut off at the time thresholds T_{TH1} and T_{TH2}, respectively. However, only one time threshold can be set, and upon reaching this time threshold, the power supply from the battery unit 101 to the motor SWN can be directly cut off.

Additionally, in the examples described earlier, there is an option to restore the normal power supply from the battery unit 101 to the motor SWN. However, this option can be canceled.

Moreover, monitoring the angular signal output by the 3-axis gyroscope 302 can also be used as an auxiliary validity judgment basis to improve the accuracy and reliability of the fall determination. For example, at a certain time threshold, based on the acceleration information α and whether the angular velocity change on one or more axes of the 3-axis gyroscope 302 exceeds the angular velocity threshold, the fall state can be determined.

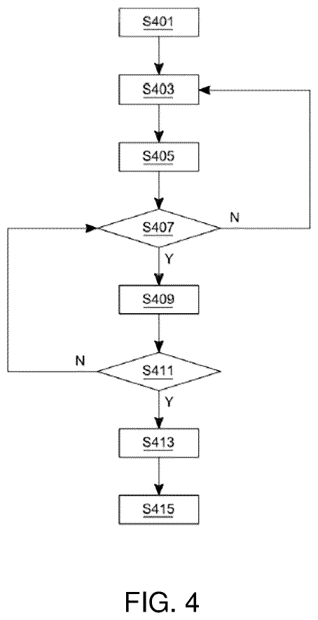

The following describes a recoil monitoring program that can be executed by the battery 100 according to an example of this application, in conjunction with FIG. 4. Recoil in an electric tool refers to the situation where, during the operation of the electric tool, the operator loses grip, causing the tool to rotate in the direction opposite to the rotation of its tool head. As shown in FIG. 4, the recoil monitoring program starts at step 401.

In step S403, the FUS 304 receives angular velocity information w at the current moment from the 3-axis gyroscope 302.

In step S405, the angular velocity information w undergoes necessary filtering and normalization processing.

In step S407, based on the processed angular velocity information w, it is determined whether the electric tool is in a recoil state.

It should be noted here that assuming the three axes of the 3-axis gyroscope 302 are X, Y, and Z axes, the angular velocity information w output by the 3-axis gyroscope 302 contains angular velocity components (ωₓ, ω_{y}, ω_{z}) around these three axes.

In the electric tool, the 3-axis gyroscope 302 can be installed such that one of its axes (e.g., the Y-axis) is approximately parallel or even coincides with the rotation axis of the tool head of the electric tool. In this case, when the value (absolute value) or sudden change of the angular velocity (e.g., ω_{y}) around that axis (e.g., Y-axis) exceeds a preset angular velocity threshold, it can be determined that the electric tool is in a recoil state.

However, in many cases, due to the layout limitations of various components in the electric tool, it is not guaranteed that one of the axes of the 3-axis gyroscope 302 is approximately parallel or coincides with the rotation axis of the tool head of the electric tool. In such cases, (ωₓ²+ω_{y}²+ω_{z}²)^{1/2} can be used as the angular velocity characterization, and when the value or sudden change of (ωₓ²+ω_{y}²+ω_{z}²)^{1/2} exceeds a preset angular velocity threshold, it can be determined that the electric tool is in a recoil state.

If the determination result in step S407 is “yes,” i.e., the electric tool is in a recoil state, the program proceeds to step S409. If the determination result in step S407 is “no,” i.e., the electric tool is not in a recoil state, the program returns to step S403.

In step S409, the timer 303 starts timing.

In step S411, it is determined whether the timing of the timer 303 has reached a preset time threshold. If the determination result in step S411 is “yes,” the program proceeds to step S413. If the determination result in step S411 is “no,” the program returns to step S407.

In step S413, the FUS 304 outputs a state indication signal representing the occurrence of recoil, which is provided as an interrupt to the CPU 401.

In step S415, based on the state indication signal representing recoil, the CPU 401 generates a switch control signal to control the switch network 102 to cut off the supply current from the battery unit 101 to the electric motor SWN.

Those skilled in the art can make various adaptive modifications to the recoil monitoring program described above based on specific applications. For example, in addition to the scheme of determining the recoil state of the electric tool based on the angular velocity (using the absolute value of the angular velocity around one axis of the 3-axis gyroscope 302, or using (ωₓ²+ω_{y}²+ω_{z}²)^{1/2}, the angle obtained from the angular velocity can also be combined as an auxiliary validity judgment basis to improve the accuracy and reliability of recoil determination. For example, the angular velocity can be integrated over time to represent the angle. At a certain time threshold (which can be the same as the time threshold in step S411), if the angular velocity exceeds the angular velocity threshold and the angle exceeds a preset angle threshold, it can be determined that the electric tool is in a recoil state. If at this time threshold, although the angular velocity exceeds the angular velocity threshold, the angle does not reach the angle threshold, the above judgment can be repeated at another time threshold after this time threshold.

In addition, in the example of the recoil monitoring program described above, different time thresholds can be set similarly to the fall monitoring program. After the recoil state reaches the corresponding time threshold, the supply current from the battery unit 101 to the electric motor SWN can be reduced and cut off respectively. Additionally, as an optional (non-essential) feature, the end of recoil can be determined by the change of angular velocity over time (e.g., becoming less than a preset threshold close to 0), and the switch network 102 can be controlled to resume normal power supply from the battery unit 101 to the electric motor SWN.

Furthermore, in the fall monitoring program and recoil monitoring program, video and/or audio output can be used to indicate the fall or recoil state of the electric tool.

Moreover, other types of sensors can be used to provide 3-axis acceleration and 3-axis angular velocity information in this application.

In the above example, the application of this disclosure is illustrated with fall and recoil monitoring as examples. However, using the control device 200 integrated with the battery 100, multiple motion detection programs can be integrated into the FUS 304 of the IMU 300, and the corresponding multiple different motion states can be indicated by outputting motion state signals with different signal values. The motion states that can be indicated by the motion state signals include the fall and recoil states described above, other abnormal motion states that need to be handled, and normal motion states that do not need to be handled (such as the operator controllably moving the electric tool).

The state indication signals mentioned earlier have a unified parameter format but different signal parameter values to indicate different motion states.

In the scheme of this application, the CPU 401 can execute corresponding control based solely on the signal value, thereby greatly simplifying the computational burden of the CPU of the electric tool itself.

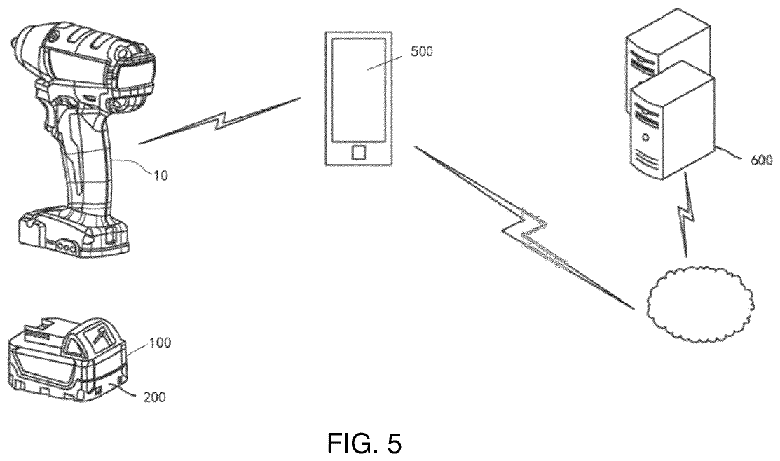

According to a further example of this application, using the communication module in the control device 200, the electric tool with the battery 100 installed can communicate with an external communication terminal. As shown in FIG. 5, using the battery equipped with the control device 200, the electric tool 10 can be registered to an external communication terminal such as the user's mobile phone 500 and communicate with it. For example, in the case of using a near-field communication network such as WiFi, the WiFi module 402 can be used to communicate with the mobile phone 500, so that the battery 100 can transmit data related to the electric tool or battery to the mobile phone 500, such as the state of the electric tool, operation statistics, tool identification, stored usage information, maintenance data, etc. These data can be stored in a memory located within the battery 100 or in a memory on the electric tool body and can be accessed by the processor 401 of the battery 100. Thus, using the mobile phone, the user can access the stored usage information or maintenance data of the electric tool. Using this tool data, the user can determine how the electric tool device 100 has been used so far, whether maintenance is recommended or has been performed in the past, and identify faulty components or other reasons for certain performance issues. Additionally, through the mobile phone 500, communication with a remote server 600, such as the service provider's server of the electric tool 100, can be achieved via a cellular network, for example, registering the electric tool 100 to the remote server using the mobile phone 500. In another example, when the module 400 is equipped with a remote communication module such as an NB-IoT module, the control device 200 can also be directly registered to the remote server.

Returning to FIG. 2, in a further example of this application, an update unit 405 can also be provided in the control device 200, which is used to receive the configuration of the electric tool from an external device such as a mobile phone, such as operating parameters, safety parameters, selecting tool modes, etc., to control the electric tool to operate according to the predetermined configuration. Furthermore, the update unit 405 can be configured to receive control commands for updating or extending the functions of the electric tool from the external device through the communication unit. For example, the update unit 405 can reprogram or burn the software updates, upgrades, or additional motion detection programs such as fall detection programs and recoil detection programs received from the server 600 into the FUS 304, thereby extending the functions of the electric tool. Here, although the illustrated update unit 405 is located within the module 400, in another example, the update unit 405 can also be disposed within the IMU 300. As an implementation, the update unit 405 can be realised by the processor 401 or the FUS 304. In the above examples of this application, the FUS 304 is implemented as a programmable controller, but in another example, it can also be realised by a general-purpose processor, which implements the motion state detection proposed in this application by executing programs located in the memory within the IMU 300.

In a further example of this application, the CPU 401 is configured to also monitor the temperature of the battery unit 101, for example, by monitoring the resistance value of the NTC (Negative Temperature Coefficient) resistor in the temperature monitoring circuit of the battery unit 101. When the CPU 401 monitors that the temperature of the battery unit 101 is higher than a preset temperature threshold, it can control to reduce or cut off the output current of the battery unit 101 to cool the battery unit 101 to an allowable range.

According to this application, the protection mechanism for the electric tool is integrated into the battery of the electric tool, which can control the battery power supply in the event of an accident to prevent damage to the tool or other objects. Additionally, the battery of the present application is suitable for different electric tools and is easy to maintain and manage. Furthermore, since the controller and processor on the battery side undertake a large amount of processing work, the computational burden of the CPU of the electric tool itself is greatly simplified.

While the present application is described herein with reference to specific embodiments, the scope of the present application is not limited to the details shown. Various modifications may be made to these details without departing from the principles of the present application.

1. A battery for an electric tool, comprising:
a battery cell;
a control device integrated into the battery cell, the control device comprising an inertial measurement unit and a communication and control module, wherein the inertial measurement unit comprises at least one sensor configured to measure at least one motion parameter of the electric tool, and a controller configured to receive the motion parameter output by the at least one sensor and generate a state indication signal indicating the motion state of the electric tool, and further wherein the communication and control module comprises a communication unit configured to communicate with external devices, and a processor configured to receive the state indication signal and generate a switch control signal; and
a switch network configured to receive the switch control signal generated by the control device and control the power output of the battery based on the switch control signal.

2. The battery according to claim 1, wherein:
the inertial measurement unit further comprises a timer configured to measure the duration of the motion state;
the controller is configured to generate different state indication signals based on the motion parameter and the duration; and
the processor is configured to generate different switch control signals based on the different state indication signals.

3. The battery according to claim 2, wherein the controller is configured to output a state indication signal when the duration exceeds a preset time threshold, such that the processor generates a switch control signal based on the state indication signal to control the switch network to cut off the power output of the battery.

4. The battery according to claim 2, wherein:
the controller is configured to output a first state indication signal when the duration exceeds a first time threshold, such that the processor generates a first switch control signal based on the first state indication signal to control the switch network to reduce the power output of the battery; and
the controller is further configured to output a second state indication signal when the duration exceeds a second time threshold greater than the first time threshold, such that the processor generates a second switch control signal based on the second state indication signal to control the switch network to cut off the power output of the battery.

5. The battery according to claim 3, wherein the processor is configured to generate a switch control signal to restore the power output of the battery to control the switch network to restore the power output of the battery after reducing or cutting off the power output of the battery, based on the motion parameter indicating a normal motion state.

6. The battery according to claim 1, wherein the motion parameter comprises 3-axis acceleration from the sensor, and the controller is configured to generate and output the state indication signal when (αₓ²+α_{y}²+α_{z}²)^{1/2} is less than a preset acceleration threshold, the state indication signal representing a fall of the electric tool.

7. The battery according to claim 6, wherein the controller is further configured to confirm the state indication signal as valid when the integral of (1−(αₓ²+α_{y}²+α_{z}²)^{1/2}) over time reaches a preset speed threshold, and generate and output the state indication signal representing a fall of the electric tool only when the state indication signal is confirmed as valid.

8. The battery according to claim 1, wherein the motion parameter further comprises 3-axis angular velocity (ωₓ, ω_{y}, ω_{z}) from the sensor, the controller being configured to generate and output the state indication signal when the value or sudden change of one of the 3-axis angular velocities or (ωₓ²+ω_{y}²+ω_{z}²)^{1/2} reaches a preset angular velocity threshold, the state indication signal representing a recoil of the electric tool.

9. The battery according to claim 8, wherein the controller is further configured to confirm the state indication signal as valid when the integral of one of the 3-axis angular velocities or (ωₓ²+ω_{y}²+ω_{z}²)^{1/2} over time reaches a preset angular threshold, and generate and output the state indication signal representing a recoil of the electric tool only when the state indication signal is confirmed as valid.

10. The battery according to claim 1, wherein the controller is configured to generate different state indication signals with a unified parameter format but different signal parameter values to respectively indicate different motion states.

11. The battery according to claim 1, wherein the controller is a programmable microcontroller specifically optimised for sensor fusion and motion recognition algorithms.

12. The battery according to claim 1, wherein the control device further comprises an update unit configured to receive control commands for updating or extending the functions of the electric tool from the external device through the communication unit.

13. The battery according to claim 12, wherein the update unit is disposed within the communication and control module or within the inertial measurement unit.

14. The battery according to claim 12, wherein the update unit is implemented by the processor or the controller.

15. The battery according to claim 1, wherein the processor is configured to send data related to the electric tool or the battery to the external device and receive instructions related to the electric tool or the battery from the external device, or modify the operating parameters related to the electric tool or the battery through the communication unit.

16. The battery according to claim 1, wherein the communication unit comprises at least one of:
a Bluetooth module;
an NB-IoT module;
a wireless cellular module; and
a positioning module.

17. The battery according to claim 1, wherein the sensor and the controller are integrated within a single chip package.

18. The battery according to claim 1, wherein the processor is configured to monitor the temperature of the battery cell and reduce or cut off the power output of the battery cell when the monitored temperature of the battery cell exceeds a preset temperature threshold.

19. The battery according to claim 18, wherein the processor is configured to monitor the temperature of the battery cell through the resistance value of a Negative Temperature Coefficient resistor in the temperature monitoring circuit of the battery cell.

20. An electric tool, comprising:
an electric motor;
the battery according to claim 1, configured to output power to the electric motor;
wherein the switch network in the battery is configured to control the power output of the battery to the electric motor based on the switch control signal.
